(19) United States
(12) Patent Application Publication
(10) Pub. No.: US 2012/0162678 A1
(43) Pub. Date: Jun. 28, 2012

(54) IMAGE FORMING APPARATUS AND IMAGE FORMING METHOD

(75) Inventor: Nobuyuki Kato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/327,984

(22) Filed: Dec. 16, 2011

Related U.S. Application Data
(60) Provisional application No. 61/425,967, filed on Dec. 22, 2010.

(51) Int. Cl. G06K 15/16; G06F 3/12

(52) U.S. Cl. 358/1.12; 358/1.13

(57) ABSTRACT

According to one embodiment, an image forming apparatus includes a reading section, a temporary memory, a thumbnail creating section, a finish-image creating section, a display section, a page selecting section, an image editing section, and a printing section. The image data generated by the reading section is temporarily stored in the temporary memory. The thumbnail creating section creates thumbnails on the basis of the image data and displays the thumbnails on the display section. The finish-image creating section creates a stereoscopic image of a finish state of a print according to a finishing instruction and displays the stereoscopic image on the display section. The page selecting section selects an arbitrary page among the thumbnails. The image editing section edits image data of the selected page. The printing section prints the image data stored in the temporary memory.

### CROSS-REFERENCE TO RELATED APPLICATION

This application is based upon and claims the benefit of U.S. Provisional Application No. 61/425,967, filed on Dec. 22, 2010.

### FIELD

Embodiments described herein relate generally to an image forming apparatus and an image forming method that can perform printing using various reading modes in combination.

### BACKGROUND

An MFP (Multi-Function Peripheral) including a printer function and a scanner function in addition to a copy function has plenty of finishing functions such as two-sided printing, N-in-1 printing, hole punching, and stapling compared with a single-function printer. The MFP can output various documents using these functions in combination. However, because the MFP includes the many functions, operation of the MFP is complicated. If a user fails in operation, the MFP cannot output an intended document, repeatedly performs printing, and wastes paper and printing materials.

There is a proof function for, in taking plural copies, printing only one copy and, after confirming that an output result of the copy is correct, printing the remaining number of copies. However, in this function, one copy has to be actually printed.

Further, when editing for combining original documents dividedly read in plural times or deleting a specific page is performed, it is necessary to once scan an image and capture the image into the MFP, send the captured image to a PC (Personal Computer) via a network, and edit the image using an exclusive application. Therefore, operation is complicated.

### DESCRIPTION OF THE DRAWINGS

FIG. 1 is a diagram of the configuration of an image forming apparatus according to an embodiment;

FIG. 2 is an overall block diagram of the image forming apparatus according to the embodiment;

FIG. 3 is a functional block diagram of an image editing section of the image forming apparatus according to the embodiment;

FIG. 4 is a diagram of a setting screen of the image forming apparatus according to the embodiment;

FIG. 5 is a diagram of an editing screen of the image forming apparatus according to the embodiment;

FIGS. 6A to 6C are diagrams for explaining a control flow of the image forming apparatus according to the embodiment; and

FIGS. 7A and 7B are diagrams of finishes of copying in the image forming apparatus according to the embodiment.

### DETAILED DESCRIPTION

In general, according to one embodiment, an image forming apparatus includes a reading section, a temporary memory, a thumbnail creating section, a finish-image creating section, a display section, a page selecting section, an image editing section, and a printing section. The reading section reads images of original documents and generates image data. The generated image data is temporarily stored in the temporary memory. The thumbnail creating section creates thumbnails on the basis of the image data stored in the temporary memory and displays the thumbnails on the display section. The finish-image creating section creates a stereoscopic image of a finish state of a print according to a finishing instruction and displays the stereoscopic image on the display section. The page selecting section selects an arbitrary page among the thumbnails. The image editing section edits image data of the selected page and writes back the image data after the editing to the temporary memory. The printing section prints the image data stored in the temporary memory.

### Embodiment

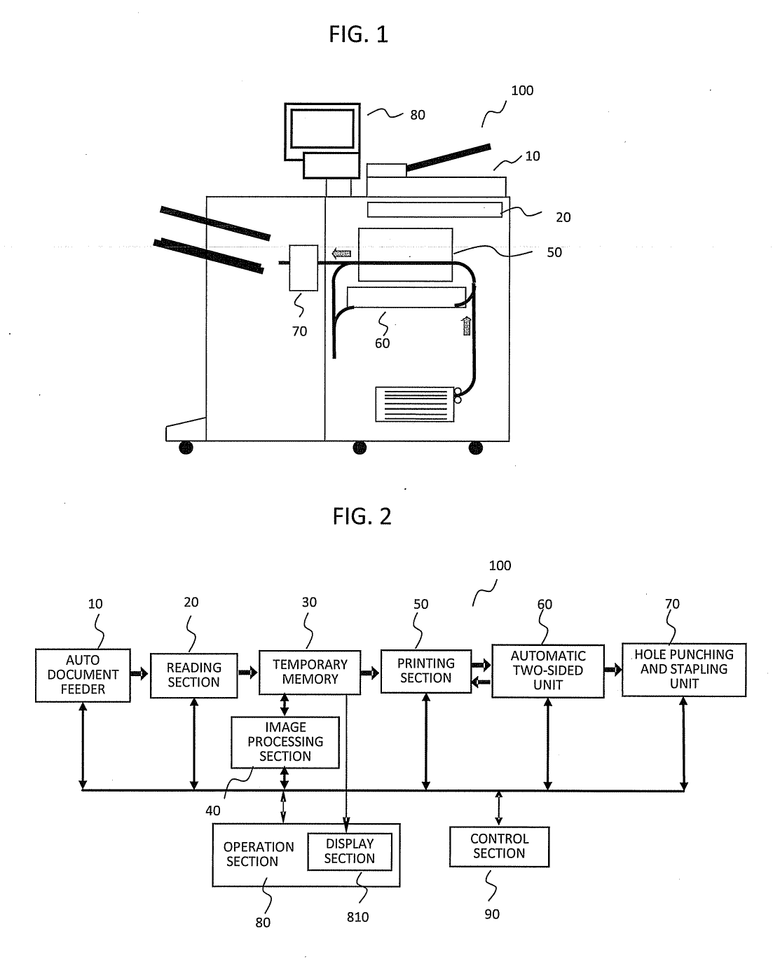

FIG. 1 is a sectional view of the configuration of an image forming apparatus according to an embodiment. A multi-function peripheral (hereinafter referred to as MFP) 100 functioning as the image forming apparatus includes a reading section 20 configured to optically read original documents set in an auto document feeder 10 while conveying the original documents one by one and generate image data, a printing section 50 configured to form toner images of C (cyan), M (magenta), Y (yellow), and K (black) on conveyed recording paper, an automatic two-sided UNIT 60 configured to reverse the recording paper and lead the recording paper to the printing section again to print an image on the rear side of the recording paper printed by the printing section 50, a hole punching and stapling unit 70 configured to bundle printed recording paper and staple the recording paper or open punch holes for binding the recording paper, and an operation section 80 configured to display setting operation and setting information of various functions of the MFP.

FIG. 2 is a block diagram of the MFP 100 shown in FIG. 1. Sections same as the sections shown in FIG. 1 are denoted by the same reference numerals. As shown in FIG. 2, the MFP 100 includes a temporary memory 30 configured to temporarily store the image data of the original documents read by the reading section 20, an image processing section 40 explained later, and the printing section 50 configured to print-output the image data stored in the temporary memory 30. In the MFP 100, a display section 810 including a touch panel is provided in the operation section 80. The MFP 100 causes the display section 810 to display selection of various printing modes, function setting keys, a setting state, and display thumbnail images explained later. Further, the MFP 100 includes a control section 90 including a CPU and storage devices such as a ROM (Read Only Memory) and a RAM (Random Access Memory), which are not shown in the figure, and an arithmetic I/O section connected to the devices. The control section 90 collectively controls the entire system of the MFP.

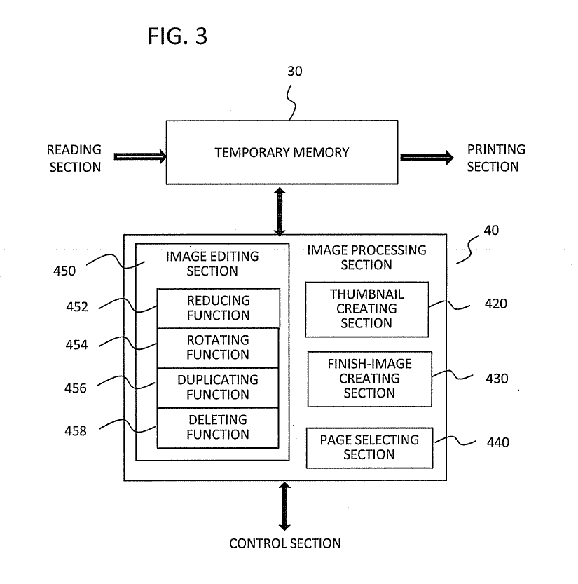

FIG. 3 is a diagram for explaining details of the image processing section 40. The image processing section 40 is connected to the temporary memory 30. The image processing section 40 includes a thumbnail creating section 420 configured to create thumbnails, a finish-image creating section 430 configured to create a finish image, a page selecting section 440 configured to select an arbitrary image out of the thumbnails, and an image editing section 450 configured to edit the image selected by the page selecting section 440, which are controlled by the control section 90.

The thumbnail creating section 420 reads out the image data stored in the temporary memory 30, creates thumbnails, which are reduced images, and writes the thumbnails in another area of the temporary memory 30 again as image data for thumbnails. The thumbnail image data written in the temporary memory 30 is displayed on the display section 810 of the operation section 80.

The finish-image creating section 430 functions when the hole punching and stapling unit 70 is used for printing setting for copying. For example, the finish-image creating section 430 causes the display section 810 to stereoscopically display a finish image according to a binding position of stapling designated by a user.

The page selecting section 440 selects an arbitrary page image out of the thumbnails displayed on the display section 810. When the user touches the display section 810, an editing processing target page explained later is selected. The page selecting section 440 further includes a function of scrolling the thumbnails using a cursor key.

The image editing section 450 reads out and performs editing processing on image data corresponding to the thumbnail selected by the page selecting section 440 and writes back the image data to the temporary memory again. The editing processing includes a reducing function 452 for reducing image data, a rotating function 454 for rotating an image by a predetermined angle, a duplicating function 456 for performing duplication of the image data, and a deleting function 458 for deleting the image data.

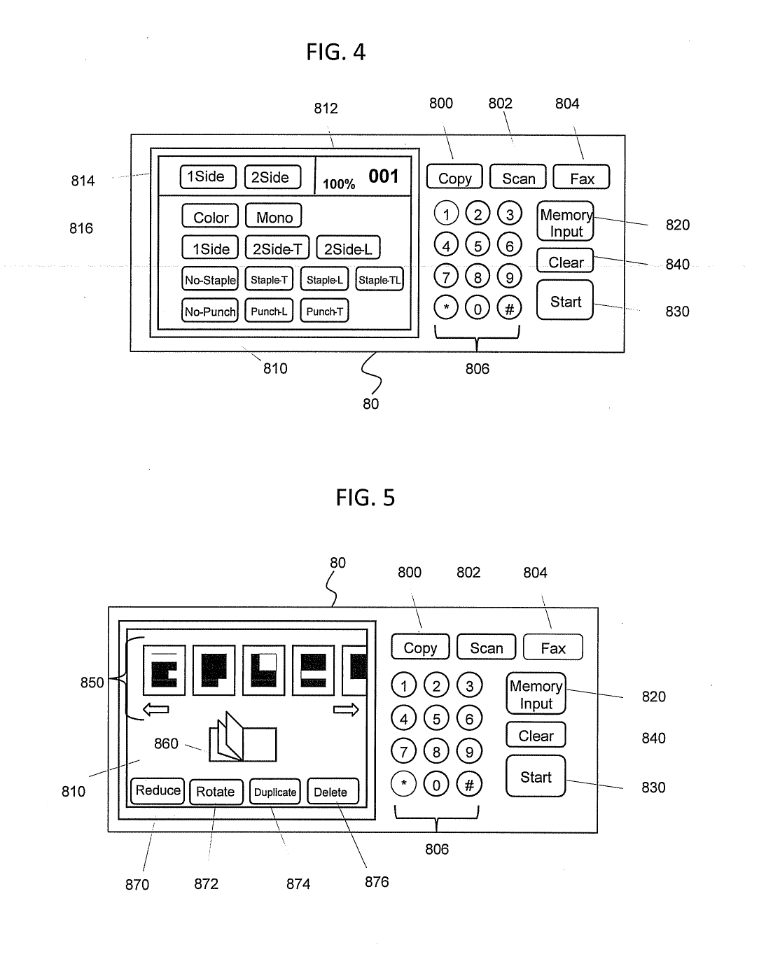

FIG. 4 is a diagram of a setting screen of the operation section 80 and the display section 810. FIG. 5 is a diagram of an editing screen of the operation section 80 and the display section 810. The operation section 80 includes a Copy key 800, a Scan key 802, and a Fax key 804 as function keys for switching functions. Further, the operation section 80 includes a ten key 806 for designating the number of copies, a Memory Input key 820, a Start key 830, and a Clear key 840. These keys are formed by hard keys.

The display section 810 is a liquid crystal panel including a touch panel and displays soft keys and thumbnails of images. Further, the display section 810 displays a state of a machine and various messages not shown. If the display section 810 is used as a copy setting screen as shown in FIG. 4, the display section 810 displays an area 812 for displaying copy magnification and the number of copies, an area 814 for designating one side and two sides of an original document, and an area 816 for selecting printing setting of a copy function. If the display section 810 is used as an image editing screen as shown in FIG. 5, the display section 810 displays thumbnails 850 and a finish image 860 and displays a reduce key 870, a rotate key 872, a duplicate key 874, and a delete key 876 as editing keys.

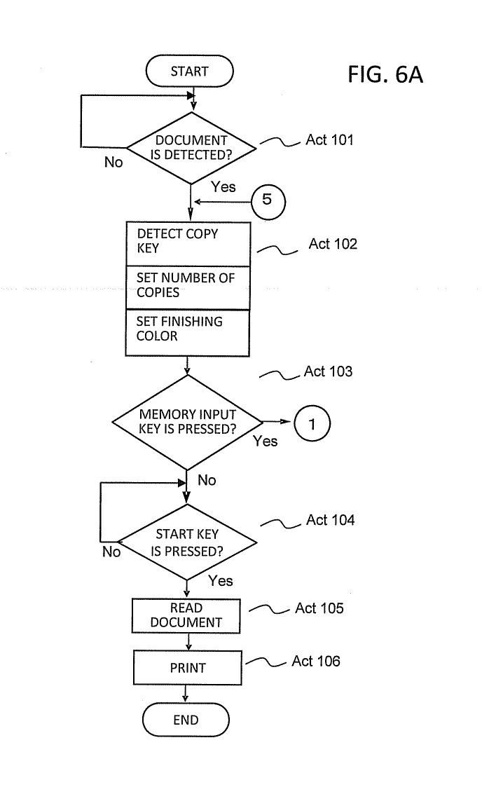

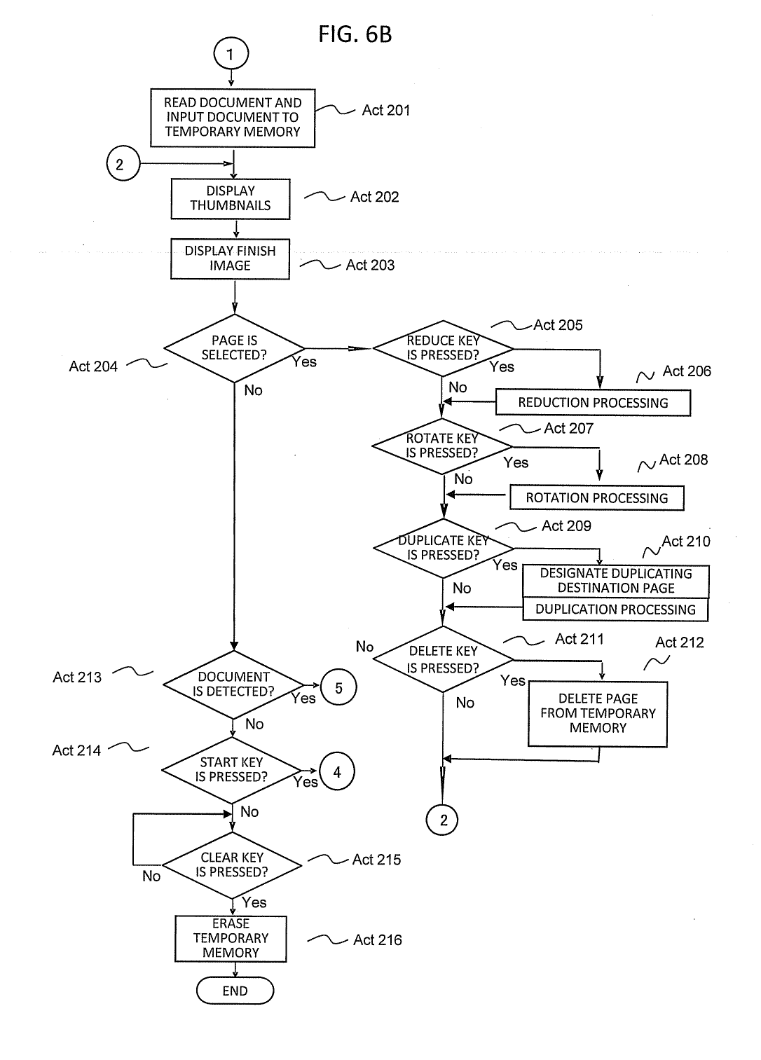

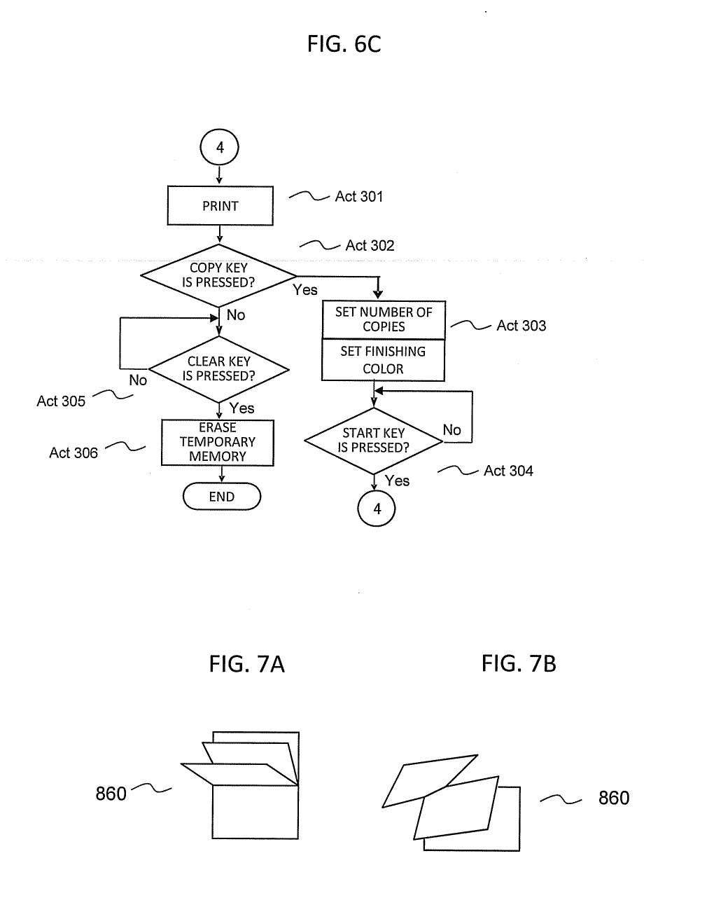

The operation of the control section 90 related to image editing of the MFP according to this embodiment is explained with reference to flowcharts of FIGS. 6A to 6C.

If the control section 90 detects that original documents are set in the auto document feeder 10 (Act 101), subsequently, the control section 90 detects that the Copy key of the function keys is pressed and switches the display section 810 of the operation section 80 to the setting screen shown in FIG. 4. On the setting screen, the number of copies and magnification set by the user are displayed in the area 812. The user selects, in the area 814 of the setting screen, whether the original documents set in the auto document feeder 10 are one-sided (1 Side) or two-sided (2 Side). Subsequently, in the area 816 of the setting screen, the user sets a printing method including finishing (hole punching and stapling in this embodiment). The user selects color or monochrome, one-sided printing or two-sided printing, whether stapling is performed, and whether hole punching is performed. In the case of the two-sided printing, the user selects top binding (2 Side-T) or left binding (2 Side-L) according to a binding direction. If the stapling is performed, the user selects top binding (Staple-T), left binding (Staple-L), or top left one-point binding (Staple-TL) according to a binding direction. If the hole punching is performed, the user selects top binding (Punch-T) or left binding (Punch-L) according to a binding direction. Consequently, setting of a copy mode is completed (Act 102).

Subsequently, the control section 90 determines whether the temporary memory 30 is used in the copy operation. Concerning the determination whether the temporary memory 30 is used, the control section 90 determines whether the Memory Input key 820 is pressed (Act 103). If the control section 90 determines that the Memory Input key 820 is pressed, the control section 90 determines that the temporary memory 30 is used. When normal copying is performed without using the temporary memory, the user presses the Start key 830 instead of the Memory Input key 820 (No in Act 103). If the control section 90 determines that the Start key 830 is pressed (Yes in Act 104), according to the set copy mode, the reading section 20 reads original documents (Act 105) and the printing section 50 executes printing of read image data (Act 106).

If the control section 90 determines in Act 103 that the Memory Input key 820 is pressed, the control section 90 instructs the auto document feeder 10 to sequentially feed the original documents set in the auto document feeder 10 to the reading section 20. The control section 90 stores read image data in the temporary memory 30 (Act 201).

When the reading is started, the display of the display section 810 is switched to the editing screen shown in FIG. 5. The thumbnail creating section 420 creates thumbnail images on the basis of the read image data. The thumbnails 850 are sequentially displayed on the editing screen (Act 202). A pair of left and right cursor keys is displayed under the thumbnails 850. When the user presses one of the cursor keys, the thumbnails 850 are scroll-displayed in one direction.

Subsequently, in Act 203, the finish-image creating section 430 creates the finish image 860 for stereoscopically displaying the thumbnails 850 according to a binding direction of stapling and causes the display section 810 to display the image 860. The user can intuitively check, by looking at the finish image 860, whether finishing is set as intended. If the top binding (Staple-T) is selected as the binding direction of stapling, the finish image 860 is displayed as shown in FIG. 7A. If the top left one-point binding (Staple-TL) is selected, the finish image 860 is displayed in a form shown in FIG. 7B. On pages of the finish image 860 created by the finish-image creating section 440, document images are reduced and displayed in a form corresponding to content of printing setting.

Editing functions for a page is explained. The editing functions for a page in this embodiment include the reducing function 452 for reducing an image at predetermined magnification, the rotating function 454 for rotating an image by a predetermined angle, the duplicating function 456 for duplicating an image, and the deleting function 458 for deleting an image.

In performing editing of a page, first, the user selects, on the touch panel, an image set as a target of the editing out of the thumbnails 850 displayed on the editing screen of the display section 810 (Act 204). Page information of the image selected by the user is acquired by the page selecting section 440.

If a page is selected in Act 204, the control section 90 determines whether the reduce key 870 displayed on the editing screen is pressed (Act 205). If the control section 90 determines that the reduce key 870 is pressed, reduction processing is executed by the reducing function 452 of the image editing section 450 (Act 206). If the control section 90 determines that the rotate key 872 is pressed (Act 207), rotation processing is executed by the rotating function 454 of the image editing section 450 (Act 208). The rotation processing may function to count the number of times the rotate key 872 is pressed and, if the rotate key 872 is pressed once, rotate the image 90 degrees in the right direction, if the rotate key 872 is pressed twice, rotate the image 180 degrees in the right direction, and, if the rotate key 872 is pressed three times, rotate the image 270 degrees in the right direction.

If the control section 90 determines that the key pressed is the duplicate key 874 (Act 209), duplication of the image is executed by the duplicating function 456 of the image editing section 450 (Act 210). Duplication processing can arrange the duplicated image in an arbitrary position by designating a duplicating destination.

If the control section 90 determines that the key pressed by the user is the delete key 876 (Act 211), the deleting function 458 of the image editing section 450 deletes the designated page. Specifically, the control section 90 deletes image data of the designated page from the temporary memory 30 (Act 212). When the image editing function is executed, a result of the image editing is displayed as thumbnails again (Act 202). The user can check content of the editing.

In copy operation, in some case, the user desires to add other original documents to original documents once read. Further, in some case, the user desires to change a reading condition and printing setting for the original documents to be added. Processing performed when original documents are added in this way is explained below. When original documents are added to image data already stored in the temporary memory 30, the user sets the additional original documents in the auto document feeder 10. If the control section 90 detects in Act 213 that the original documents are set in the auto document feeder 10, subsequently, the control section 90 detects that the Copy key 800 of the function keys is pressed and switches the display section 810 of the operation section 80 to the setting screen shown in FIG. 4 again. The user can change reading setting or printing setting according to necessity (Act 102). Subsequently, if the control section 90 detects that the Memory Input key 820 is pressed (Yes in Act 103), the additional original documents set in the auto document feeder 10 are read according to setting and read image data is stored in the temporary memory 30 following the image data stored in the temporary memory 30 (Act 201). When the reading is started, the display section 810 of the operation section 80 is switched to the editing screen shown in FIG. 5 again and the thumbnails 850 of the additional original documents are displayed following the thumbnails of the first original documents. Therefore, the various editing functions by the image editing section 450 can be executed as in the first time.

After all the additional documents are stored in the temporary memory 30 and the editing ends, if there is no original document to be added, the user presses the Start key 830. If the control section 90 detects the pressing of the Start key 830, the control section 90 starts printing of the image stored in the temporary memory 30 (Act 301).

During the printing in Act 301 or after the end of the printing, if the user presses the Copy key 800 (Act 302), the display section 810 of the operation section 80 is switched to the setting screen shown in FIG. 4 again. The user can perform printing in different setting by, for example, changing the finishing setting (Act 303) and pressing the Start key 830 (Act 304). In other words, it is possible to change only an output form and perform printing without reading original documents anew. If this operation is performed during the printing, the printing in the different setting is reserved and is performed following the end of the preceding printing.

After the end of the printing, if the Copy key 800 is not pressed (No in Act 302) and the Clear key 840 is pressed (Act 305), the printing setting and the data in the temporary memory 30 are erased (Act 306). The control section 90 ends the series of copy operation.

If the user presses the Clear key 840 (Act 215) before printing of the image data stored in the temporary memory 30 is instructed, i.e., without pressing the Start key 830 in Act 214 (No in Act 214), as in the case explained above, the printing setting and the data in the temporary memory 30 are erased (Act 216). The control section 90 ends the copy operation.

If there are further additional original documents, in a state in which the thumbnails 850 are displayed on the editing screen, the user can additionally read the original documents by setting the original documents to be added in the auto document feeder 10 and pressing the Copy key 800.

Through the use of the temporary memory, it is possible to combine different reading modes in one copying by reading original documents and accumulating the original documents in the temporary memory while changing reading setting. For example, if a booklet including two-sided copies in the former half and one-sided copies in the latter half is created, it is possible to cause the MFP to perform processing up to stapling in one printing and labor and time are saved compared with the related art in which the original documents are copied in different kinds of reading setting in the former half and the latter half and then the copies are manually bound.

In addition, it is possible to perform plural times of printing while changing output setting using a result of one original document reading. For example, when the user desires to take ten copies in color and twenty copies in monochrome, in the related art, there is no choice but to perform copying twice. However, reading has to be performed only once by performing output once from the temporary memory for each of color and monochrome while changing setting. Therefore, it is possible to save time and suppress damage to original documents.

In the embodiment explained above, reduction, rotation, duplication, and deletion are explained as the functions of the image editing section. However, the functions of the image editing section are not limited to these functions and may be a function of moving an image to a predetermined position and a function of reversing an image.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image forming apparatus comprising:
a reading section configured to read images of original documents and generate image data;
a temporary memory configured to temporarily store the image data;
a thumbnail creating section configured to create thumbnails on the basis of the image data stored in the temporary memory;
a finish-image creating section configured to create a stereoscopic image of a finish state of a print according to a finishing instruction from an operation section;
a display section configured to display the thumbnails and the finish image;
a page selecting section configured to select an arbitrary page among the thumbnails displayed on the display section;
an image editing section configured to edit image data of the selected page and write back the image data after the editing to the temporary memory; and
a printing section configured to print the image data stored in the temporary memory according to an instruction for start of printing.

2. The apparatus according to claim 1, wherein the image editing section includes one of a reducing function, a rotating function, a duplicating function, and a deleting function.

3. The apparatus according to claim 1, wherein the operation section includes a clear key for erasing all the image data stored in the temporary memory and erasing setting information by the operation section.

4. The apparatus according to claim 1, wherein the operation section includes a memory input key for instructing start of the reading by the reading section and instructing the storage of the image data read by the reading section in the temporary memory.

5. The apparatus according to claim 4, wherein the operation section includes a start key for instructing start of the reading by the reading section and instructing the printing of the image data read by the reading section.

6. The apparatus according to claim 1, further comprising an auto document feeder, wherein
if the apparatus detects that original documents are set in the auto document feeder before printing of the image data stored in the temporary memory is instructed, the apparatus adds image data of the original documents set in the auto document feeder to the temporary memory.

7. The apparatus according to claim 1, wherein the display section includes a touch panel and displays a setting screen for setting an image forming mode and an editing screen for performing image editing.

8. The apparatus according to claim 1, wherein the finish-image creating section switches a display form between top binding and top left one-point binding selected as binding directions of stapling.

9. The apparatus according to claim 8, wherein images of original documents reduced in a form corresponding to content of printing setting are displayed, on the display section, in pages of a finish image created by the finish-image creating section.

10. The apparatus according to claim 3, wherein the image data stored in the temporary memory can be repeatedly printed with printing setting changed until the erasing by the clear key is executed.

11. An image forming method comprising:
reading images of original documents and generating image data;
temporarily storing the image data in a temporary memory;
creating thumbnails on the basis of the image data stored in the temporary memory;
creating a stereoscopic image of a finish state of a print according to a finishing instruction from an operation section;
displaying the thumbnails and the finish image on a display section;
selecting an arbitrary page among the thumbnails displayed on the display section;
editing image data of the selected page and writing back the image data after the editing to the temporary memory; and
printing the image data stored in the temporary memory according to an instruction for start of printing.

12. The method according to claim 11, wherein the editing of the image data is one of a reducing function, a rotating function, a duplicating function, and a deleting function.

13. The method according to claim 11, further comprising erasing, with a clear key, all the image data stored in the temporary memory and erasing setting information by the operation section.

14. The method according to claim 11, further comprising instructing, with a memory input key, the start of the printing and the storage of the read image data in the temporary memory.

15. The method according to claim 14, further comprising instructing, with a start key, start of the reading and the printing of the read image data.

16. The method according to claim 11, further comprising adding, if it is detected that original documents are set in an auto document feeder before printing of the image data stored in the temporary memory is instructed, image data of the original documents set in the auto document feeder to the temporary memory.

17. The method according to claim 11, wherein the display section includes a touch panel and displays a setting screen for setting an image forming mode and an editing screen for performing image editing.

18. The method according to claim 11, further comprising switching a display form between top binding and top left one-point binding selected as binding directions of stapling.

19. The method according to claim 18, wherein images of original documents reduced in a form corresponding to content of printing setting are displayed in pages of a finish image displayed on the display section.

20. The method according to claim 13, wherein the image data stored in the temporary memory can be repeatedly printed with printing setting changed until the erasing by the clear key is executed.
